(19) United States
(12) Patent Application Publication
(10) Pub. No.: US 2024/0427877 A1
(43) Pub. Date: Dec. 26, 2024

(54) Malicious Log Entry Filtering

(71) Applicant: International Business Machines Corporation, Armonk, NY (US)

(72) Inventors: Aaron K. Baughman, Cary, NC (US); Christopher A. Kulakowski, Austin, TX (US); Ramon Lloyd Garo, Miami, FL (US); Mauro Marzorati, Lutz, FL (US)

(21) Appl. No.: 18/337,514

(22) Filed: Jun. 20, 2023

(51) Int. Cl. G06F 21/55; G06F 21/60

(52) U.S. Cl. CPC G06F 21/552; G06F 21/602; G06F 2221/034

(57) ABSTRACT

A computer implemented method processes log entries. A number of processor units identify log entries. The number of processor units determines whether anomalous content is present in the log entries. The number of processor units suppresses the anomalous content to form suppressed content in response to determining that the anomalous content is present in the log entries. According to other illustrative embodiments, a computer system and a computer program product for processing log entries are provided.

### BACKGROUND

The disclosure relates generally to an improved computer system and more specifically to filtering log entries to eliminate malicious actions on a computer system.

Logs are used to record and store information about events and activities occurring in a computer system. Logs can be used for many purposes such as troubleshooting, monitoring, performance analysis, and other actions.

The data contained in the logs may include commands that are hidden in log entries. This type of data can sometimes be added to perform malicious actions on a computer. Log entries can be used as a communications channel for malicious actions. Malicious actions include, for example, log injection in which malicious content in the logs can manipulate the behavior of the application processing the log. This type of malicious action can include escalating privileges, executing code, or obtaining unauthorized access.

### SUMMARY

According to one illustrative embodiment, a computer implemented method processes log entries. A number of processor units identify log entries. The number of processor units determines whether anomalous content is present in the log entries. The number of processor units suppresses the anomalous content to form suppressed content in response to determining that the anomalous content is present in the log entries. According to other illustrative embodiments, a computer system and a computer program product for processing log entries are provided.

### BRIEF DESCRIPTION OF THE DRAWINGS

FIG. 1 is a block diagram of a computing environment in accordance with an illustrative embodiment;

FIG. 2 is a block diagram of a log environment in accordance with an illustrative embodiment;

FIG. 3 is an illustration of a log analyzer in accordance with an illustrative embodiment;

FIG. 4 is a diagram illustrating dataflow in processing log entries in accordance with an illustrative embodiment;

FIG. 5 is an illustration of suppressing anomalous content in a log entry in accordance with an illustrative embodiment;

FIG. 6 is a flowchart of a process for processing log entries in accordance with an illustrative embodiment;

FIG. 7 is a flowchart of a process for processing log entries in accordance with an illustrative embodiment;

FIG. 8 is a flowchart of a process for sending log entries in accordance with an illustrative embodiment;

FIG. 9 is a flowchart of a process for determining whether anomalous content is present in accordance with an illustrative embodiment;

FIG. 10 is a flowchart of a process for determining whether anomalous content is present in accordance with an illustrative embodiment;

FIG. 11 is a flowchart of a process for suppressing anomalous content in accordance with an illustrative embodiment;

FIG. 12 is a flowchart of a process for suppressing anomalous content in accordance with an illustrative embodiment;

FIG. 13 is a flowchart of a process for suppressing anomalous content in accordance with an illustrative embodiment;

FIG. 14 is a flowchart of additional steps for suppressing anomalous content in accordance with an illustrative embodiment; and

FIG. 15 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

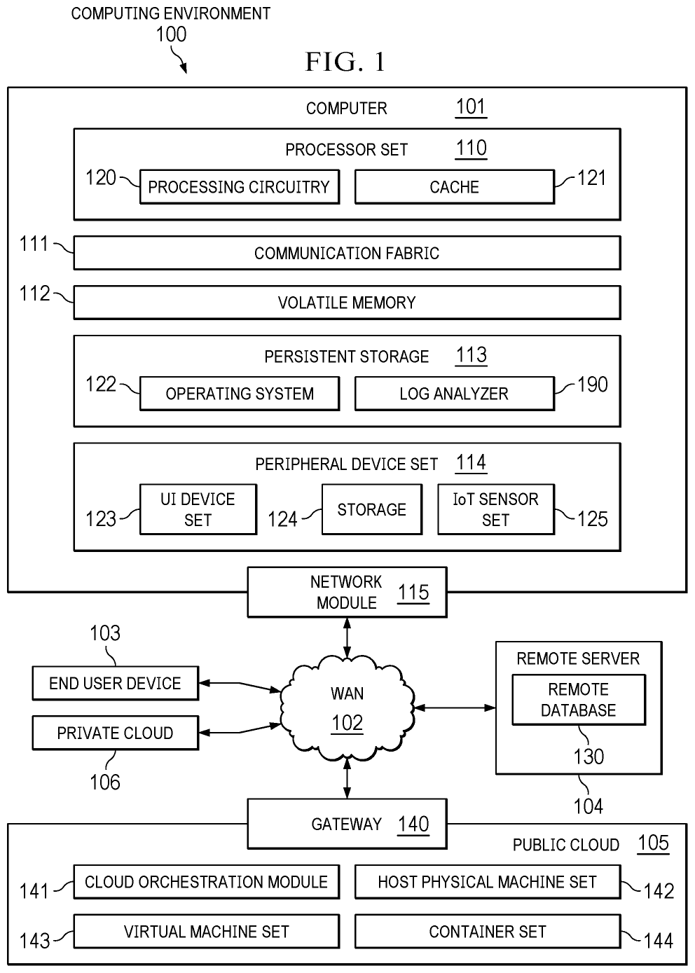

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as log analyzer 190. In addition to log analyzer 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and log analyzer 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in log analyzer 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in log analyzer 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Illustrative embodiments recognize and take into account a number of different considerations as described herein. For example, currently logs such as Web server logs are rarely monitored by security software. As result, malicious content in the logs may be missed. For example, information can be included in logs that can cause a logging component to run malicious code. This code can allow an attacker to take control of a system or perform other malicious behaviors.

Thus, illustrative embodiments provide a method, apparatus, computer system, and program code to analyze logs for undesired content. In the illustrative examples, the undesired content can be neutralized in response to detecting that content in log entries.

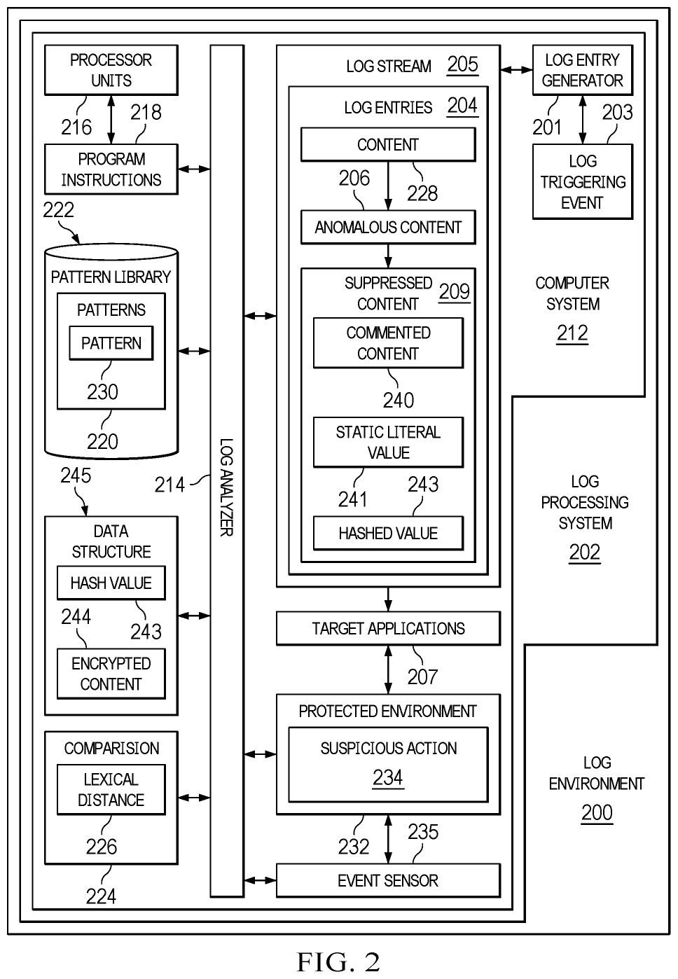

With reference now to FIG. 2, a block diagram of a log environment is depicted in accordance with an illustrative embodiment. In this illustrative example, log environment 200 includes components that can be implemented in hardware such as the hardware shown in computing environment 100 in FIG. 1.

In this illustrative example, log processing system 202 operates to process log entries 204. These log entries can be generated by log entry generator 201 in response to a log triggering event 203. Log entry generator 201 can take a number of different forms. For example, log entry generator 201 can be a network device, a Web server, a database, an application server, a security system, an intrusion detection system, a logging framework, or other suitable processes or applications. In this example, log triggering event 203 can also take a number of different forms. For example, log triggering event 203 can be a user login, a user log out, an exception occurrence, an applications start up, an application shutdown, a resource access, a configuration change, occurrence of a performance metric exceeding a threshold, importing data, or other suitable event.

In this illustrative example, log analyzer 214 can process log entries 204 to determine whether anomalous content 206 is present in log entries 204. These log entries can be located in log stream 205 or data structures such as log files that are sent to target application 207 for processing. These log files can also be referred to as “logs”.

In this illustrative example, log processing system 202 comprises computer system 212 and log analyzer 214. Log analyzer 214 is located in computer system 212.

Log analyzer 214 can be implemented in software, hardware, firmware or a combination thereof. When software is used, the operations performed by log analyzer 214 can be implemented in program instructions configured to run on hardware, such as a processor unit. When firmware is used, the operations performed by log analyzer 214 can be implemented in program instructions and data and stored in persistent memory to run on a processor unit. When hardware is employed, the hardware can include circuits that operate to perform the operations in log analyzer 214.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer readable program instructions.

As used herein, a processor unit in the number of processor units 216 is a hardware device and is comprised of hardware circuits such as those on an integrated circuit that respond to and process instructions and program code that operate a computer. A processor unit can be implemented using processor set 110 in FIG. 1. When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different type of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this example, log analyzer 214 identifies log entries 204 for target application 207. The target application is an application that uses log entries 204. In the illustrative examples, log entry generator 201 can be a separate application, agent, or process within target application 207.

In one illustrative example, log analyzer 214 identifies log entries 204 through intercepting log entries 204 destined for use by target application 207. In this example, log entries 204 are intercepted and processed to identify and suppress anomalous content 206 prior to sending log entries 204 to target application 207. The processed log entries can be sent to target application 207 by placing those log entries into a log, a data store, or some other data structure for use by target application 207. In this manner, potential malicious activity can be prevented when target application 207 processes log entries 204.

Log analyzer 214 determines whether anomalous content 206 is present in log entries 204. In this illustrative example, anomalous content 206 can be content that deviates from what is considered normal or expected behavior. The amount of deviation can indicate whether a potential security concern is present in the content.

In one illustrative example, log analyzer 214 can determine whether anomalous content 206 is present by comparing log entries 204 to patterns 220 in pattern library 222 to form comparison 224. In this example, patterns 220 are patterns known for malicious content to form a comparison 224. Log analyzer 214 then determines whether anomalous content 206 is present is present using comparison 224.

In one illustrative example, the comparison may include lexical distance 226. In this illustrative example, lexical distance 226 is a measure of the similarity or difference between constructs such as content within patterns 220. The comparison of content with patterns 220 can include a comparison of keywords, identifiers, symbols, or other constructs. Content 228 in log entries 204 is anomalous content 206 when content 228 has lexical distance 226 to pattern 230 in patterns 220 that is within a threshold for potentially malicious content.

In another illustrative example, log analyzer 214 can determine whether anomalous content 206 is present by sending log entries 204 to target application 207, running in protected environment 232. In this illustrative example, protected environment 232 is an environment that prevents any malicious activity or unwanted actions occurring within protected environment 232 from affecting other environments or systems. In this example, protected environment 232 can be a secure isolated space in which target application 207 can run without posing risks to other applications or data.

Protected environment 232 can be implemented in a number of different ways. For example, protected environment 232 can be implemented using a hypervisor, a container, or some other mechanism that operates as sandbox or demilitarized zone (DMZ) to provide a safe space.

Log analyzer 214 can determine whether suspicious action 234 occurs in response to the target application 207 processing log entries 204 within protected environment 232. In this example, event sensor 235 or other mechanisms can be used to detect events such as suspicious action 234. In this example, suspicious action 234 can be a malicious action or other action that does not normally occur when processing a log entry.

Further, the detection of suspicious action 234 in protected environment 232 can be used to identify potential malicious content that does not match a pattern in patterns 220. In one illustrative example, a pattern is created by log analyzer 214 using the anomalous content causing the suspicious action 234 in response to suspicious action 234 occurring in protected environment 232. This pattern is added to patterns 220 in pattern library 222.

In this example, log analyzer 214 suppresses anomalous content 206 to form suppressed content 209 in response to determining anomalous content 206 is present in log entries 204. In suppressing anomalous content 206, log analyzer 214 takes measures to restrict or limit the ability or influence that anomalous content 206 can have to cause damage or perform other malicious actions in a system or program. In other words, anomalous content 206 can be modified or removed to restrict or prevent anomalous content 206 from performing undesired or unintended actions.

Anomalous content 206 can be suppressed in a number of different ways by log analyzer 214. For example, log analyzer 214 can perform commenting out anomalous content 206. With this example, suppressed content 209 is in the form of commented content 240 rather than content that can actually be processed to initiate or cause an action. In other words, this content can be deactivated or prevented from being executed when log entries 204 processed.

In another example, anomalous content 206 can be replaced by log analyzer 214 with static literal value 241. Static literal value 241 is a fixed value that does not change.

In another illustrative example, log analyzer 214 can suppress anomalous content 206 by hashing anomalous content 206 to form hash value 243 and replace anomalous content 206 with hash value 243. With hash value 243, this value cannot be reversed to obtain anomalous content 206. In illustrative example, log analyzer 214 can also encrypt anomalous content 206 to form encrypted content 244. Log analyzer 214 can store hash value 243 and encrypted content 244 as an entry in a data structure 245. In this manner, the hash value 243 in log entries 204 can be used to locate encrypted content 244 in the data structure. Encrypted content 244 can then be decrypted using a key to obtain anomalous content 206 for review or other uses.

Further, log analyzer 214 can send log entries 204 with suppressed content 209 to target application 207. Target application 207 can then process log entries 204. Target application is not aware that log entries 204 have been processed by log analyzer 214.

In one illustrative example, one or more solutions are present that overcome a problem with security issues in log entries. As a result, one or more solutions may provide processing of log entries to identify anomalous content and suppress that anomalous content. This processing can be performed when log entries are generated and sent to a log or other place for storage. In other illustrative examples, in addition to intercepting log entries for target applications, the process can be performed on already stored log entries. Further, the illustrative examples can ensure the integrity of log entries prior to sending the log entries to a log or other location. The incoming log entries can be compared to the process log entries to be sent to determine whether inconsistencies in the number of log entries are present.

Computer system 212 can be configured to perform at least one of the steps, operations, or actions described in the different illustrative examples using software, hardware, firmware or a combination thereof. As a result, computer system 212 operates as a special purpose computer system in which log analyzer 214 in computer system 212 enables detecting and suppressing anomalous content in log entries. This detection and suppression can be performed in real time as log entries are generated and sent to a destination. The illustrative examples can intercept the log entries and process them before they log entries are sent to the destination, this destination can be a log, or directly to a target application. In particular, log analyzer 214 transforms computer system 212 into a special purpose computer system as compared to currently available general computer systems that do not have log analyzer 214.

In the illustrative example, the use of log analyzer 214 in computer system 212 integrates processes into a practical application for method processing log entries that increases the performance of computer system 212. In other words, log analyzer 214 in computer system 212 is directed to a practical application of processes integrated into log analyzer 214 in computer system 212 that determines whether anomalous content is present in log entries in suppresses the anomalous content that is found in the log entries. In the illustrative examples, this process can be performed as log entries are being generated and streamed or placed in a location for processing such as a log.

The illustration of log environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, identifying log entries 204 can be performed by receiving selections of log entries for searching for log entries stored in a database. In this example, log entries may not be analyzed in real time but can be used to determine whether previously stored log entries have anomalous content. In this case, log entries 204 may not be located in log stream 205. Instead, these log entries may be located in a database or other suitable data structure.

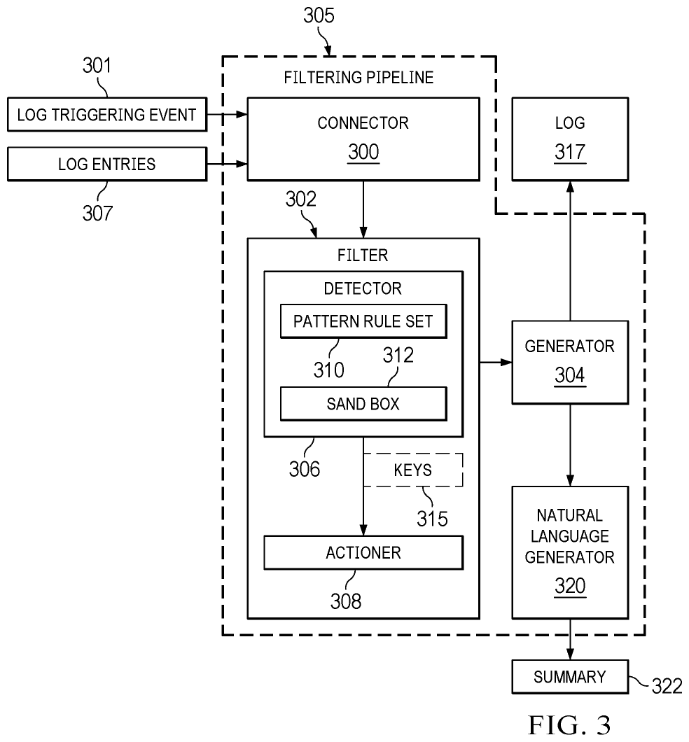

Turning next to FIG. 3, a diagram of components in a log analyzer implemented in a pipeline is depicted in accordance with an illustrative embodiment. In this illustrative example, connector 300, filter 302, and generator 304 are examples of components that can be used to implement log analyzer 214 in FIG. 2. In this example these components form filtering pipeline 305 for processing log entries prior to those log entries being sent for use by a target application. This example implementation illustrates the use of these components to intercept log entries generated by a log generation process.

In this illustrative example, log triggering event 301 results in connector 300 intercepting log entries 307 generated from a log generation process. Connector 300 is an entry point into filtering pipeline 305. Connector 300 can be implemented using a number of different techniques.

For example, in UNIX-like environments through the use of the “I” symbol, to provide inter-process communication between the program and the filtering function. In another example, connector 300 can be part of a module or plugin, such as Apache's mod_log_config, which provides the filtering function internally. Connector 300 can be part of a standalone program, such as rsyslog, syslog-ng, or other suitable programs that implements the syslog protocol.

In this illustrative example, connector 300 sends log entries 307 to filter 302 for processing. As depicted, filter 302 comprises detector 306 and actioner 308.

Detector 306 includes pattern rule set 310 and sandbox 312. These components are used to detect anomalous content within log entries 307.

In this example, pattern rule set 310 is a regular expression (regex) pattern rule set. This pattern rule set can include patterns of regular expressions that match execution vulnerabilities such as such as Remote Code Execution (RCE), Log File Inclusion (LFI), command injection, Cross-site Request Forgery (CSFR), PHP object injection, and other vulnerabilities. The format of these and many other vulnerabilities have a common predictable format that can be identified using regular expression pattern matching.

Further in this example, pattern rule set 310 can also identify content that resembles script blocks like php, javascript, vb, and other script blocks. Some logging or web applications may execute script blocks in specific scenarios. The script blocks can be detected by tags or beginning and ending syntax, in this example.

In some cases, new log based attack vectors or log entries that are obfuscated can be present. These types of log entries can be detected using other techniques such as placing the log entries in the protected environment such as sandbox 312. Detector 306 can implement a symmetric logging component on-host to “detect” potentially harmful log entries.

For example, detector 306 can use an area on the system that models a real logging application with a sensor to identify any unexpected API interactions with the operating system. In this illustrative example, this area on the system is sandbox 312. Actions such as spawning a process, establishing a network connection, allocation of memory, reading or writing to disk, and other actions that a log entry should not be able to perform can be detected by the sensor. If abnormal actions are identified, the sensor indicates that a particular log entry has performed an abnormal action for a log entry.

Thus, in this example, detector 306 identifies content in log entries 307 that are identified as having anomalous content using pattern rule set 310 and sandbox 312. These identifications are used by actioner 308 to suppress the anomalous content identified by detector 306.

In this example, the identifications can be sent to actioner 308 using keys 315. Each key in keys 315 provides information about the anomalous content detected in a log entry by detector 306. A key identifies anomalous content, and the location of the anomalous content in a log entry. In identifying the anomalous content, a key can include the string comprising the anomalous content.

Further, a key can also indicate the type of threat that may be present. For example, the key can indicate whether the anomalous content is a script block, a directory traversal, a local command injection, an application command injection, a vendor specific vulnerability, or other type of threat. These types of threats can be determined based on what patterns the anomalous content matches. These patterns can include identification of threat types that can be used to generate keys 315.

For example, actioner 308 can operate to obfuscate the log entry to “break” it's functionality by either obfuscating the entry in its entirety, replacing the anomalous portion of the log entry with a hash that is referenceable on an external table of anomalies, a combination of these two, or outright removal or replacement of the log entry. These and other types of actions suppress the ability of anomalous content to perform or initiate undesired activities. This type of action performed on anomalous content in a log entry can referred to as “defanging” the anomalous content in log entries.

After log entries 307 have been processed by filter 302, generator 304 outputs log entries 307 to be sent to a destination such as log 317. In this illustrative example, generator 304 can be implemented using different techniques for outputting and sending log entries 307 to a destination. In one example, generator 304 can output log entries 307 in a manner expected by the target application that will process the log entries. For example, generator 304 can output log entries 307 to a local linear file, circular buffers, output to a socket, or other suitable destinations.

Additionally, generator 304 also ensures that data loss does not occur with the processing of log entries 307. In this illustrative example, generator 304 can compare the number of log entries 307 received by connector 300 to the number of log entries to the output to log 317. If the processed log entries to be output to log 317 do not match the number of received log entries plus the number of in-process entries, the 304 throws an exception and flushes the entire buffer before terminating connector 300 and filter 302 in this example.

In another illustrative example, generator 304 can use natural language generator 320 to generate summary 322 in a human readable form. In other words, summary 322 does not include the syntax used in log entries 307. In other words, this syntax is translated by natural language generator 320 to generate human readable content for summary 322. This summary can be sent to a user for review. The user can be, for example, a system administrator, a network administrator, a security analyst, a support engineer, a compliance officer, or other user.

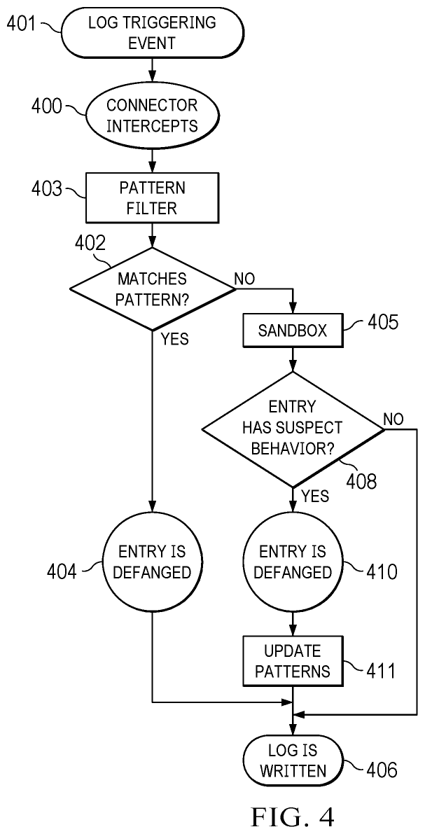

With reference now to FIG. 4, a diagram illustrating dataflow in processing log entries is depicted in accordance with an illustrative embodiment. The process in this example can be implemented in log analyzer 214 in FIG. 2 and in particular in an implementation of log analyzer 214 using filtering pipeline 305 in FIG. 3.

In this example, the dataflow begins with log triggering event 401. The data flow in this example is performed for each entry received in response to log triggering event 401.

In response to this event, a connector intercepts the log entries (step 400). Log entries are sent to a pattern filter 403. Pattern filter 403 contains a pattern rule set, such as pattern rule set 310 in FIG. 3. Pattern filter 403 generates a result from comparing each log entry to the patterns implemented in the pattern rule set. A determination is made as to whether a match to a pattern is present (step 402). If a match is present, the log entry is defanged (step 404). The defanged log entry is then written to a log (step 406).

With reference again to step 402, if a match to a pattern is not present, the process sends the log entry to sandbox 405. Sandbox 405 is a protected environment in which actions performed within this environment do not affect other components for devices in a system. As depicted, sandbox 405 can be a hypervisor, a container, or other suitable components. The log entry is sent to a target application in sandbox 405.

A determination is made as to whether the log entry has suspect behavior (step 408). If the log entry has suspect behavior, the log entry is defanged (step 410).

The process updates patterns (step 411). In step 411, the process updates patterns used by pattern filter 403 with the pattern from the log entry causing suspect behavior in sandbox 405. This pattern is added in response to the log entry causing suspect behavior. In this example, the anomalous content causing the suspect behavior can be identified in the log entry and added to a pattern in pattern filter 403.

In this manner, pattern filter 403 can be updated in response to determining log entries not matched by pattern filter 403 causing the suspect behavior in sandbox 405. With this example, sandbox 405 can be used to provide feedback to pattern filter 403 in a manner that enables pattern filter 403 to detect new log entries that have anomalous content.

The defanged log entry is written to a log (step 406). The process proceeds directly to step 406 if the entry does not have suspect behavior in sandbox 405.

In this example, this data flow is followed for each log entry received in response to log triggering event 401. In other words, connector intercepts log entries as they are streamed or generated.

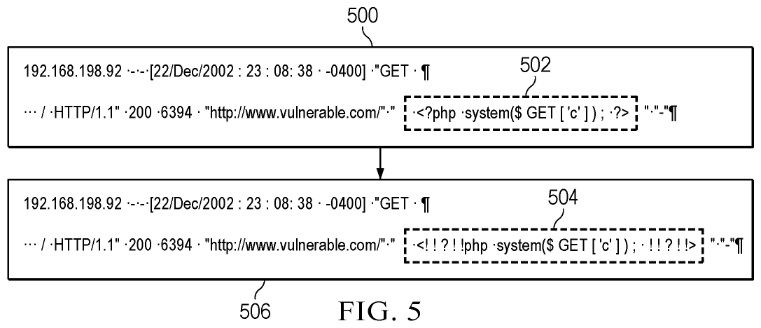

With reference next to FIG. 5, an illustration of suppressing anomalous content in a log entry is depicted in accordance with an illustrative embodiment. This suppression can be performed using log analyzer 214 in FIG. 2 and in particular using components such as actioner 308 in filter 302 in FIG. 3. In this example, log entry 500 is an example of a log entry received for processing. As depicted, log entry 500 includes a hypertext preprocessor (PHP) script 502. In this example, PHP script 502 is anomalous content in log entry 500. A key can be generated to identify the script using the opening and closing brackets.

In this depicted example, log entry 500 is processed to suppress this anomalous content. The suppression can also be referred to as “defanging”. As depicted, symbols such as “!” are added to PUP script 502 to form suppressed content 504 in processed log entry 506. The addition of this symbol to the opening closing brackets breaks the syntax of this PHP script block rendering this anomalous content inactive or defanged. Processed log entry 506 can then be sent to a generator for output.

Although these components have been depicted for use in intercepting log events, these components can also be used to process log entries that have already been generated and stored in a data structure. For example, these components can be used to process log entries stored in log files in directories or locations within a system. In other words, the illustrative example can be used to analyze and suppress anomalous content for entries that have been placed into log files sent to a target application.

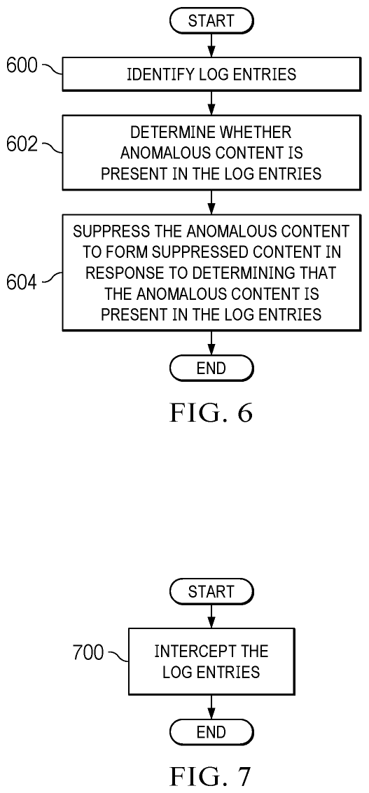

Turning next to FIG. 6, a flowchart of a process for processing log entries is depicted in accordance with an illustrative embodiment. The process in FIG. 6 can be implemented in hardware, software, or both. When implemented in software, the process can take the form of program instructions that are run by one of more processor units located in one or more hardware devices in one or more computer systems. For example, the process can be implemented in log analyzer 214 in computer system 212 in FIG. 2.

The process begins by identifying log entries (step 600). The process determines whether anomalous content is present in the log entries (step 602).

The process suppresses the anomalous content to form suppressed content in response to determining that the anomalous content is present in the log entries (step 604). The process terminates thereafter. In step 604, the suppression is performed for each log entry in which anomalous content is present.

With reference to FIG. 7, a flowchart of a process for identifying log entries is depicted in accordance with an illustrative embodiment. This figure illustrates an implementation for step 600 in FIG. 6.

The process intercepts the log entries (step 700). The process terminates thereafter. In some examples, the log entries can be identified from user input selecting files, logs, databases or other structures in which log entries can be stored.

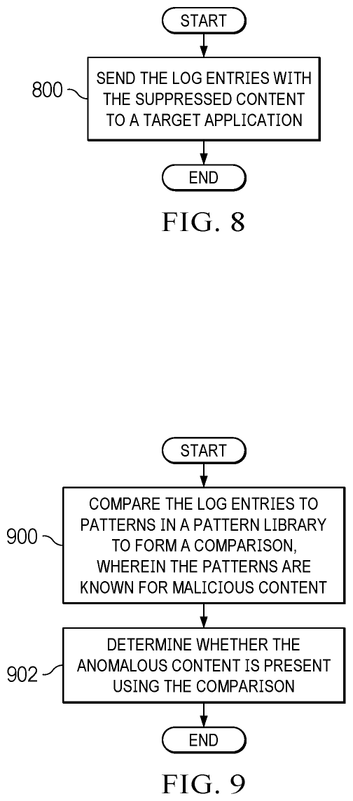

Next in FIG. 8, a flowchart of a process for sending log entries is depicted in accordance with an illustrative embodiment. The step in this flowchart is an example of an additional step that can be performed with the steps in FIG. 6.

The process sends the log entries with the suppressed content to a target application (step 800). The process terminates thereafter.

Turning to FIG. 9, a flowchart of a process for determining whether anomalous content is present is depicted in accordance with an illustrative embodiment. The process in this figure is an example of an implementation for step 602 In FIG. 6.

The process compares the log entries to patterns in a pattern library to form a comparison, wherein the patterns are known for malicious content (step 900). The process determines whether the anomalous content is present using the comparison (step 902). The process terminates thereafter. In this example, content in the log entries is anomalous content when the content has a lexical distance to a pattern in the patterns that is within a threshold for potentially malicious content.

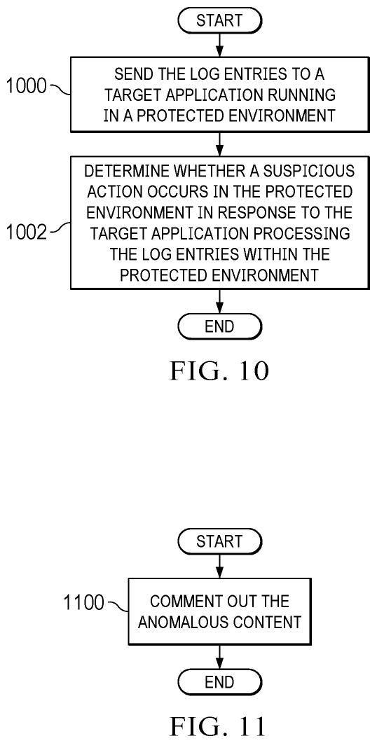

In FIG. 10, a flowchart of a process for determining whether anomalous content is present is depicted in accordance with an illustrative embodiment. The process in this figure is an example of an implementation for step 602 in FIG. 6.

The process sends the log entries to a target application running in a protected environment (step 1000). The process determines whether a suspicious action occurs in the protected environment in response to the target application processing the log entries within the protected environment (step 1002). The process terminates thereafter.

Turning next to FIG. 11, a flowchart of a process for suppressing anomalous content is depicted in accordance with an illustrative embodiment. The process in this figure is an example of an implementation for step 604 in FIG. 6.

The process comments out the anomalous content (step 1100). The process terminates thereafter.

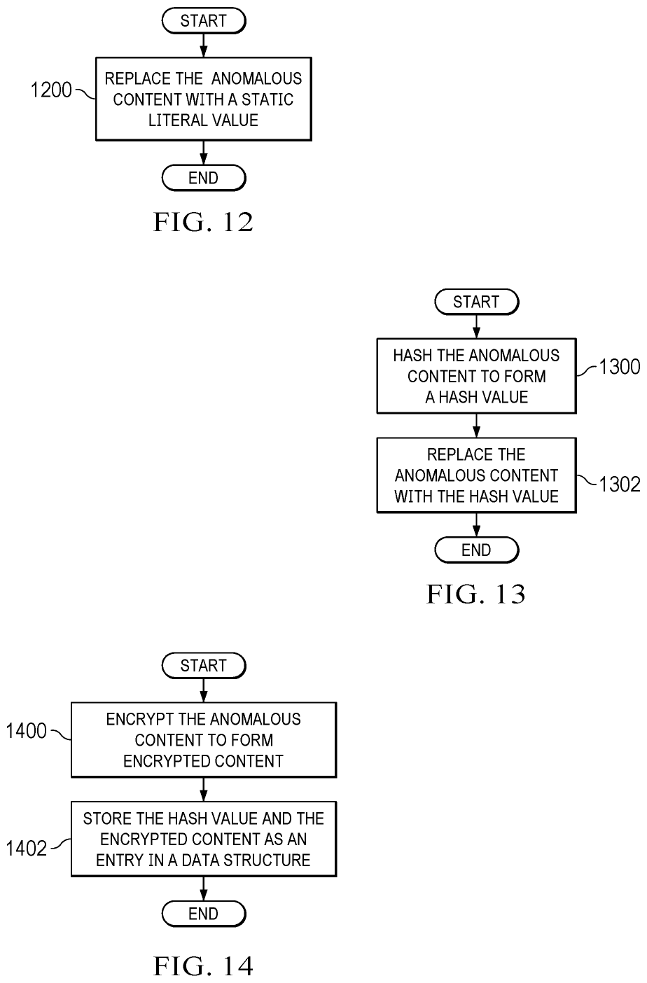

Referring now to FIG. 12, another flowchart of a process for suppressing anomalous content is depicted in accordance with an illustrative embodiment. The process in this figure is an example of an implementation for step 604 in FIG. 6.

The process replaces the anomalous content with a static literal value (step 1200). The process terminates thereafter.

Turning to FIG. 13, yet another flowchart of a process for suppressing anomalous content is depicted in accordance with an illustrative embodiment. The steps in this figure are an example of an implementation for step 604 in FIG. 6.

The process hashes the anomalous content to form a hash value (step 1300). The process replaces the anomalous content with the hash value (step 1302). The process terminates thereafter.

In FIG. 14, a flowchart of additional steps for suppressing anomalous content is depicted in accordance with an illustrative embodiment. The process in this figure is an example of additional steps that can be performed with the steps in FIG. 13.

The process encrypts the anomalous content to form encrypted content (step 1400). The process stores the hash value and the encrypted content as an entry in a data structure (step 1402). The process terminates thereafter. With the hash value and encrypted content, the anomalous content can be decrypted for review at a later time. Encrypting the anomalous content can prevent unintended execution of the content.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

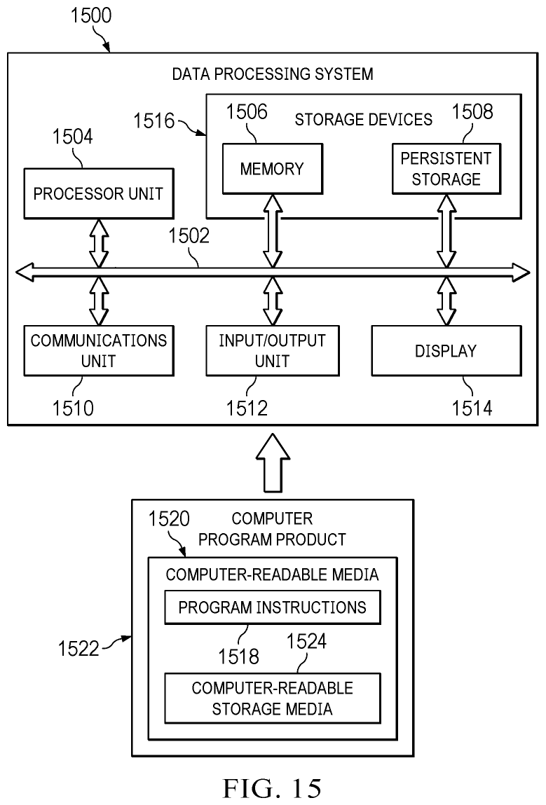

Turning now to FIG. 15, a block diagram of a data processing system is depicted in accordance with an illustrative embodiment. Data processing system 1500 can be used to implement computers and computing devices in computing environment 100 in FIG. 1. Data processing system 1500 can also be used to implement computer system 212 in FIG. 2. In this illustrative example, data processing system 1500 includes communications framework 1502, which provides communications between processor unit 1504, memory 1506, persistent storage 1508, communications unit 1510, input/output (I/O) unit 1512, and display 1514. In this example, communications framework 1502 takes the form of a bus system.

Processor unit 1504 serves to execute instructions for software that can be loaded into memory 1506. Processor unit 1504 includes one or more processors. For example, processor unit 1504 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1504 can be implemented using one or more heterogeneous processor systems in which a main processor is present with secondary processors on a single chip. As another illustrative example, processor unit 1504 can be a symmetric multi-processor system containing multiple processors of the same type on a single chip.

Memory 1506 and persistent storage 1508 are examples of storage devices 1516. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1516 may also be referred to as computer readable storage devices in these illustrative examples. Memory 1506, in these examples, can be, for example, a random-access memory or any other suitable volatile or non-volatile storage device. Persistent storage 1508 may take various forms, depending on the particular implementation.

For example, persistent storage 1508 may contain one or more components or devices. For example, persistent storage 1508 can be a hard drive, a solid-state drive (SSD), a flash memory, a rewritable optical disk, a rewritable magnetic tape, or some combination of the above. The media used by persistent storage 1508 also can be removable. For example, a removable hard drive can be used for persistent storage 1508.

Communications unit 1510, in these illustrative examples, provides for communications with other data processing systems or devices. In these illustrative examples, communications unit 1510 is a network interface card.

Input/output unit 1512 allows for input and output of data with other devices that can be connected to data processing system 1500. For example, input/output unit 1512 may provide a connection for user input through at least one of a keyboard, a mouse, or some other suitable input device. Further, input/output unit 1512 may send output to a printer. Display 1514 provides a mechanism to display information to a user.

Instructions for at least one of the operating system, applications, or programs can be located in storage devices 1516, which are in communication with processor unit 1504 through communications framework 1502. The processes of the different embodiments can be performed by processor unit 1504 using computer-implemented instructions, which may be located in a memory, such as memory 1506.

These instructions are referred to as program instructions, computer usable program instructions, or computer readable program instructions that can be read and executed by a processor in processor unit 1504. The program instructions in the different embodiments can be embodied on different physical or computer readable storage media, such as memory 1506 or persistent storage 1508.

Program instructions 1518 are located in a functional form on computer readable media 1520 that is selectively removable and can be loaded onto or transferred to data processing system 1500 for execution by processor unit 1504. Program instructions 1518 and computer readable media 1520 form computer program product 1522 in these illustrative examples. In the illustrative example, computer readable media 1520 is computer readable storage media 1524.

Computer readable storage media 1524 is a physical or tangible storage device used to store program instructions 1518 rather than a medium that propagates or transmits program instructions 1518. Computer readable storage media 1524, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1518 can be transferred to data processing system 1500 using a computer readable signal media. The computer readable signal media are signals and can be, for example, a propagated data signal containing program instructions 1518. For example, the computer readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 1520” can be singular or plural. For example, program instructions 1518 can be located in computer readable media 1520 in the form of a single storage device or system. In another example, program instructions 1518 can be located in computer readable media 1520 that is distributed in multiple data processing systems. In other words, some instructions in program instructions 1518 can be located in one data processing system while other instructions in program instructions 1518 can be located in one data processing system. For example, a portion of program instructions 1518 can be located in computer readable media 1520 in a server computer while another portion of program instructions 1518 can be located in computer readable media 1520 located in a set of client computers.

The different components illustrated for data processing system 1500 are not meant to provide architectural limitations to the manner in which different embodiments can be implemented. In some illustrative examples, one or more of the components may be incorporated in or otherwise form a portion of, another component. For example, memory 1506, or portions thereof, may be incorporated in processor unit 1504 in some illustrative examples. The different illustrative embodiments can be implemented in a data processing system including components in addition to or in place of those illustrated for data processing system 1500. Other components shown in FIG. 15 can be varied from the illustrative examples shown. The different embodiments can be implemented using any hardware device or system capable of running program instructions 1518.

Thus, illustrative embodiments of the present invention provide a computer implemented method, computer system, and computer program product for processing log entry to remove anomalous content in the log entries. A computer implemented method processes log entries. A number of processor units identifiers log entries. The number of processor units determines whether anomalous content is present in the log entries. The number of processor units suppresses the anomalous content to form suppressed content in response to determining that the anomalous content is present in the log entries. According to other illustrative embodiments, a computer system and a computer program product for processing log entries are provided.

The illustrative examples can reduce the occurrence of surreptitious communications caused by programs that generate log entries in response to various activities. The illustrative examples can be integrated or added into current applications to process log entries. Other illustrative examples can be implemented as a standalone program that interacts with current logging systems.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for processing log entries, the computer implemented method comprising:
identifying, by a number of processor units, the log entries;
determining, by the number of processor units, whether anomalous content is present in the log entries; and
suppressing, by the number of processor units, the anomalous content to form suppressed content in response to determining that the anomalous content is present in the log entries.

2. The computer implemented method of claim 1, wherein identifying, by a number of processor units, the log entries comprises:
intercepting, by the number of processor units, the log entries.

3. The computer implemented method of claim 2 further comprising:
sending, by the number of processor units, the log entries with the suppressed content to a target application.

4. The computer implemented method of claim 1, wherein determining, by the number of processor units, whether the anomalous content is present comprises:
comparing, by the number of processor units, the log entries to patterns in a pattern library to form a comparison, wherein the patterns known for malicious content; and
determining, by the number of processor units, whether the anomalous content is present using the comparison.

5. The computer implemented method of claim 4, wherein content in the log entries is the anomalous content when the content has a lexical distance to a pattern in the patterns that is within a threshold for potentially malicious content.

6. The computer implemented method of claim 1, wherein determining, by the number of processor units, whether the anomalous content is present comprises:
sending, by the number of processor units, the log entries to a target application running in a protected environment; and
determining, by the number of processor units, whether a suspicious action occurs in the protected environment in response to the target application processing the log entries within the protected environment.

7. The computer implemented method of claim 6, further comprising:
creating a pattern using the anomalous content causing the suspicious action in response to the suspicious action occurring in the protected environment;
adding the pattern to patterns in a pattern library.

8. The computer implemented method of claim 1, wherein suppressing, by the number of processor units, the anomalous content comprises:
commenting out, by the number of processor units, the anomalous content.

9. The computer implemented method of claim 1, wherein suppressing, by the number of processor units, the anomalous content comprises:
replacing, by the number of processor units, the anomalous content with a static literal value.

10. The computer implemented method of claim 1, wherein suppressing, by the number of processor units, the anomalous content comprises:
hashing, by the number of processor units, the anomalous content to form a hash value; and
replacing, by the number of processor units, the anomalous content with the hash value.

11. The computer implemented method of claim 10, wherein suppressing, by the number of processor units, the anomalous content comprises:
encrypting, by the number of processor units, the anomalous content to form encrypted content; and
storing the hash value and the encrypted content as an entry in a data structure.

12. A computer system comprising:
a number of processor units, wherein the number of processor units executes program instructions to:
identify log entries;
determine whether anomalous content is present in the log entries; and
suppress the anomalous content to form suppressed content in response to determining that the anomalous content is present in the log entries.

13. The computer system of claim 12, wherein in identifying the log entries, the number of processor units further executes the program instructions to:
intercept the log entries.

14. The computer system of claim 13, wherein the number of processor units further executes the program instructions to:
send the log entries with the suppressed content to a target application.

15. The computer system of claim 12, wherein in determining whether the anomalous content is present, the number of processor units further executes the program instructions to:
compare the log entries to patterns in a pattern library to form a comparison, wherein the patterns known for malicious content; and
determine whether the anomalous content is present using the comparison.

16. The computer system of claim 15, wherein content in the log entries is the anomalous content when the content has a lexical distance to a pattern in the patterns that is within a threshold for potentially malicious content.

17. The computer system of claim 12, wherein in determining whether the anomalous content is present, the number of processor units further executes the program instructions to:
send the log entries to a target application running in a protected environment; and
determine whether a suspicious action occurs in the protected environment in response to the target application processing the log entries within the protected environment.

18. The computer system of claim 12, wherein in suppressing the anomalous content, the number of processor units further executes the program instructions to:
comment out the anomalous content.

19. The computer system of claim 12, wherein in suppressing the anomalous content, the number of processor units further executes the program instructions to:
replace the anomalous content with a static literal value.

20. A computer program product for processing log entries, the computer program product comprising a computer readable storage medium having program instructions embodied therewith, the program instructions executable by a computer system to cause the computer system to:
identify the log entries;
determine whether anomalous content is present in the log entries; and
suppress the anomalous content to form suppressed content in response to determining that the anomalous content is present in the log entries.
